(19) United States
(12) Patent Application Publication
(10) Pub. No.: US 2008/0230960 A1
(43) Pub. Date: Sep. 25, 2008

(54) Method for manufacturing information recording medium, method for forming resin mask, transferring apparatus, and light-transmitting stamper

(75) Inventors: Narutoshi Fukuzawa, Tokyo (JP); Daisuke Yoshitoku, Kawasaki-shi (JP); Minoru Fujita, Tokyo (JP); Tsuyoshi Komaki, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/076,424

(22) Filed: Mar. 18, 2008

(30) Foreign Application Priority Data
Mar. 19, 2007 (JP) 2007-071513

(51) Int. Cl. B29C 35/08

(52) U.S. Cl. 264/496; 425/174.4

(57) ABSTRACT

An information recording medium manufacturing method is provided in which a resin material can be reliably cured even when a light-transmitting stamper is used repeatedly. A resin mask forming method and a transferring apparatus and a light-transmitting stamper used in these methods are also provided. In the above methods, a visible light curable resin material is spread over a workpiece. Then, a light-transmitting stamper including a transferring portion having a predetermined concavo-convex pattern formed therein is brought into contact with the resin material to transfer the concavo-convex pattern to the resin material, and light including visible light is projected onto the resin material through the light-transmitting stamper to cure the resin material.

### BACKGROUND OF THE INVENTION

1. Field of the Invention

The present invention relates to a method for manufacturing an information recording medium having a recording layer formed to have a concavo-convex pattern, to a method for forming a resin mask, and to a transferring apparatus and a light-transmitting stamper used in the above methods.

2. Description of the Related Art

In a known conventional method for manufacturing information recording media having a recording layer formed to have a concavo-convex pattern, a resin material is spread over a workpiece, and a light-transmitting stamper including a transferring portion having a predetermined concavo-convex pattern formed therein is brought into contact with the resin material to transfer the concavo-convex pattern to the resin material. Then, light is projected onto the resin material through the light-transmitting stamper to cure the resin material. Note that the optical material for optical recording media is preferably colorless, and therefore an ultraviolet curable resin which is cured by the irradiation of ultraviolet rays in the invisible range is used for the optical material. Moreover, such an ultraviolet curable resin which is cured by the irradiation of ultraviolet rays in the invisible range is also preferably used because deterioration due to sunlight or light from illumination lamps can be suppressed. On the other hand, various types of light-transmitting resin, glass, and the like are used as the material for the light-transmitting stamper.

For example, an optical recording medium having two or more information layers has a light-transmitting spacer layer provided between adjacent ones of the information layers. First, a first information layer is formed over a substrate formed to have a concavo-convex pattern, and an ultraviolet curable resin material is spread over the first information layer. Then, a light-transmitting stamper is brought into contact with the resin material to transfer a concavo-convex pattern to the resin material, and ultraviolet light is projected onto the resin material through the light-transmitting stamper to cure the resin material, whereby a spacer layer having the concavo-convex patterns on both sides is formed. Then, a second information layer is formed over the spacer layer, whereby two information layers having respective concavo-convex patterns can be formed (see, for example, Japanese Patent Application Laid-Open No. 2006-40459).

In view of the circumstances described below, the method in which a resin layer is formed to have a concavo-convex pattern using a light-transmitting stamper is expected to be used also in order to manufacture magnetic recording media.

Conventionally, a significant improvement in the areal density of magnetic recording media such as hard disks has been achieved by, for example, reducing the size of magnetic particles constituting a recording layer, changing materials, and improving the precision of head processing. A further improvement in the areal density is expected in the future.

However, problems such as the limit of head processing, incorrect recording of information on a track adjacent to a target recording track caused by the broadening of a recording magnetic field and crosstalk during reproduction have become apparent. Therefore, the improvement of the areal density by conventional improvement techniques has reached the limit. In view of this, discrete track media and patterned media having a recording layer divided into a plurality of recording elements have been proposed as candidates for magnetic recording media in which a further improvement in the areal density can be achieved (for example, Japanese Patent Application Laid-Open No. Hei 9-97419).

IBE (ion beam etching) in which an inert gas such as Ar is used and RIE (reactive ion etching) in which CO gas containing a nitrogen-containing gas such as NH₃ gas is used as a reaction gas can be used as the technique for processing the recording layer into a concavo-convex pattern.

Specifically, a resin material with a concavo-convex pattern is formed over a continuous recording layer of a workpiece having the recording layer or the like formed over a substrate, and therefore the recording layer can be processed to have a concavo-convex pattern according to the concavo-convex pattern of the resin material. Moreover, a technique has been proposed in which one or a plurality of mask layers are formed between the recording layer and the layer of the resin material and then the mask layer(s) and the recording layer are successively processed to have a concavo-convex pattern according to the concavo-convex pattern of the resin material.

In order to form a resin material with a concavo-convex pattern over a recording layer, it is expected to utilize the above-described method using a light-transmitting stamper.

However, when a resin material with a concavo-convex pattern is formed by means of the method using a light-transmitting stamper, the resin material may not be cured sufficiently. More specifically, when a single light-transmitting stamper is repeatedly used, the extent of curing of the resin material tends to decrease even at the same ultraviolet irradiation intensity and time as the number of times of use of the light-transmitting stamper increases. This may cause a problem in that the concavo-convex pattern transferred to the resin material is deformed when the light-transmitting stamper is peeled from the resin material. Also, another problem arises in that the resin material adheres to the transferring portion of the light-transmitting stamper.

The above problems can be solved by allowing the light-transmitting stamper to be used only once or limited several times and replacing the stamper before it deteriorates. However, the manufacturing cost increases.

### SUMMARY OF THE INVENTION

In view of the foregoing problems, various exemplary embodiments of this invention provide a method for manufacturing an information recording medium in which a resin material can be reliably cured even when a light-transmitting stamper is repeatedly used. Various exemplary embodiments of this invention also provide a method for forming a resin mask, and a transferring apparatus and a light-transmitting stamper used in the above methods.

In various exemplary embodiments of the present invention, the above object is achieved by a method including: spreading a resin material which is visible light curable over a workpiece; and bringing a light-transmitting stamper including a transferring portion having a predetermined concavo-convex pattern formed therein into contact with the resin material to transfer the concavo-convex pattern to the resin material and projecting light including visible light onto the resin material through the light-transmitting stamper to cure the resin material.

Moreover, in various exemplary embodiments of the present invention, the above object is achieved by a transferring apparatus including: a stamper stage which can apply a pressure to a transferring target through a light-transmitting stamper including a transferring portion having a predetermined concavo-convex pattern formed therein; and an irradiation apparatus. In the transferring apparatus, light in which an integrated intensity of light components having wavelengths longer than those of ultraviolet rays is greater than an integrated intensity of ultraviolet components can be projected onto the transferring target through the light-transmitting stamper.

Furthermore, in various exemplary embodiments of the present invention, the above object is achieved by a transferring apparatus including: a stamper stage which can apply a pressure to a transferring target through a light-transmitting stamper including a transferring portion having a predetermined concavo-convex pattern formed therein; an irradiation apparatus which can project light including visible light onto the transferring target through the light-transmitting stamper; and a filter which is disposed between the transferring portion of the light-transmitting stamper and the irradiation apparatus and can reduce an irradiation intensity of light emitted from the irradiation apparatus such that an amount of reduction in irradiation intensity of ultraviolet components is greater than an amount of reduction in irradiation intensity of light components having wavelengths longer than those of ultraviolet rays.

Moreover, in various exemplary embodiments of the present invention, the above object is achieved by a light-transmitting stamper which includes a transferring portion having a predetermined concavo-convex pattern formed therein and in which a transmittance thereof for ultraviolet rays is less than a transmittance thereof for light having wavelengths longer than those of the ultraviolet rays.

In the course of arriving at the present invention, the present inventors have conducted intensive studies on the reasons why the extent of curing of a resin material decreases even at the same ultraviolet irradiation intensity and time as the number of times of use of a single repeatedly-used light-transmitting stamper increases. The inventors have found that the light-transmitting stamper deteriorates when irradiated with ultraviolet light, so that the amount of the ultraviolet light passing therethrough decreases gradually. In other words, the ratio of ultraviolet light absorbed by the light-transmitting stamper to the incident ultraviolet light increases gradually, and the ratio of ultraviolet light reaching the resin material decreases gradually, so that the extent of curing of the resin material decreases.

FIG. 14 is a graph showing the relationship between the wavelength of light projected onto a light-transmitting stamper and the absorptance of the light-transmitting stamper. In FIG. 14, the curve labeled with symbol A represents the data for a light-transmitting stamper which is not irradiated with light and in which the accumulated light quantity of light components having wavelengths within the range of 320 to 400 nm is 0 J/cm². The curve labeled with symbol B represents the data for a light-transmitting stamper which is irradiated with light and in which the accumulated light quantity of components having wavelengths within the range of 320 to 400 nm and contained in the irradiation light is 1 J/cm². Furthermore, the curve labeled with symbol C represents the data for a light-transmitting stamper in which the accumulated light quantity of components having wavelengths within the range of 320 to 400 nm and contained in the irradiation light is 10 J/cm².

FIG. 15 is a graph showing the relationship between the accumulated light quantity of light components having wavelengths within the range of 320 to 400 nm and contained in light projected onto a light-transmitting stamper and the absorptance of the light-transmitting stamper for light having a wavelength of 400 nm and projected onto the light-transmitting stamper.

Note that the material for the light-transmitting stamper was polyolefin having an amorphous structure. As the irradiation apparatus, Spot-Cure (registered trademark) SP5 (product of USHIO INC.) provided with a xenon lamp serving as a light source was used. FIG. 16 is a graph showing the relationship between the wavelength of light contained in the light emitted from the irradiation apparatus and the relative intensity.

As shown in FIGS. 14 and 15, it has been found that the absorptance of the light-transmitting stamper tends to increase with an increase in the accumulated light quantity of components having wavelengths within the range of 320 to 400 nm and contained in the light projected onto the light-transmitting stamper. In particular, this tendency is remarkable for the absorptance of the light-transmitting stamper for light having wavelengths of 400 nm or less.

However, when a visible light curable resin material is used and the resin material is irradiated with light including visible light, the resin material absorbs the visible light and is cured sufficiently. Specifically, if the irradiation light includes ultraviolet light, the light-transmitting stamper deteriorates, and the amount of the ultraviolet light passing through the light-transmitting stamper decreases gradually, so that the ratio of the ultraviolet light reaching the resin material decreases. Even in this case, the resin material absorbs the visible light and is cured sufficiently.

In the case in which the resin material is cured by irradiation not only with visible light but also with ultraviolet light, the curing of the resin material may be inhibited to some extent if the amount of ultraviolet light reaching the resin material decreases gradually. However, since a reduction in the amount of visible light reaching the resin material is less than a reduction in the amount of ultraviolet light reaching the resin material, the curing of the resin material is less inhibited as compared to the case in which an ultraviolet curable resin that is not visible light curable is used.

Preferably, the resin material is irradiated with light in which the integrated intensity of light components having wavelengths longer than those of ultraviolet rays (or light components having wavelengths longer than 400 nm) is greater than the integrated intensity of ultraviolet components (or light components having wavelengths of 400 nm or less). In this manner, the effect of suppressing insufficient curing of the resin material due to a reduction in the amount of ultraviolet light (or light having wavelengths of 400 nm or less) reaching the resin material can be enhanced.

It is considered that the increase of the absorptance of the light-transmitting stamper is mainly caused by repeated irradiation of the light-transmitting stamper with ultraviolet light (or light having wavelengths of 400 nm or less).

By irradiating the resin material with light in which the integrated intensity of light components having wavelengths longer than those of ultraviolet rays is greater than the integrated intensity of ultraviolet components, the deterioration of the light-transmitting stamper and the increase in absorptance due to the deterioration can also be suppressed.

As described above, in various exemplary embodiments of the present invention, the visible light curable resin material is used, and therefore the resin material is reliably cured even when the light-transmitting stamper is used repeatedly. Accordingly, various exemplary embodiments of the present invention have been made based on a concept totally different from that in the conventional technology in which an ultraviolet curable resin that is cured when irradiated with ultraviolet light in non-visible range is always used when a light-transmitting stamper is used.

Accordingly, various exemplary embodiments of this invention provide a method for manufacturing an information recording medium, comprising: a resin material spreading step of spreading a resin material which is visible light curable over a workpiece; and a transferring step of bringing a light-transmitting stamper including a transferring portion having a predetermined concavo-convex pattern formed therein into contact with the resin material to transfer the concavo-convex pattern to the resin material and projecting light including visible light onto the resin material through the light-transmitting stamper to cure the resin material.

Moreover, various exemplary embodiments of this invention provide a method for forming a resin mask, comprising: a resin material spreading step of spreading a resin material which is visible light curable over a workpiece; and a transferring step of bringing a light-transmitting stamper including a transferring portion having a predetermined concavo-convex pattern formed therein into contact with the resin material to transfer the concavo-convex pattern to the resin material and projecting light including visible light onto the resin material through the light-transmitting stamper to cure the resin material Furthermore, various exemplary embodiments of this invention provide a transferring apparatus comprising: a stamper stage which can apply a pressure to a transferring target through a light-transmitting stamper including a transferring portion having a predetermined concavo-convex pattern formed therein; and an irradiation apparatus, wherein light in which an integrated intensity of light components having wavelengths longer than those of ultraviolet rays is greater than an integrated intensity of ultraviolet components can be projected onto the transferring target through the light-transmitting stamper.

Alternatively, various exemplary embodiments of this invention provide a transferring apparatus comprising: a stamper stage which can apply a pressure to a transferring target through a light-transmitting stamper including a transferring portion having a predetermined concavo-convex pattern formed therein; an irradiation apparatus which can project light including visible light onto the transferring target through the light-transmitting stamper; and a filter which is disposed between the transferring portion of the light-transmitting stamper and the irradiation apparatus and can reduce an irradiation intensity of light emitted from the irradiation apparatus such that an amount of reduction in irradiation intensity of ultraviolet components is greater than an amount of reduction in irradiation intensity of light components having wavelengths longer than those of ultraviolet rays.

Moreover, various exemplary embodiments of this invention provide a light-transmitting stamper comprising a transferring portion having a predetermined concavo-convex pattern formed therein, wherein a transmittance thereof for ultraviolet rays is less than a transmittance thereof for light having wavelengths longer than those of the ultraviolet rays.

In the present application, the term “integrated intensity” is used to refer to a value obtained by dividing a curve in a graph showing the relationship between the wavelength and irradiation intensity of light into a large number of small regions having a small wavelength width and adding up the products of the wavelength width of each small region and the irradiation intensity within a predetermined wavelength range.

According to various exemplary embodiments of the present invention, a resin material can be reliably cured even when a light-transmitting stamper is used repeatedly.

### BRIEF DESCRIPTION OF THE DRAWINGS

FIG. 1 is a radial cross-sectional view schematically illustrating the structure of a starting body of a workpiece in a magnetic recording medium manufacturing method according to a first exemplary embodiment of the present invention;

FIG. 2 is a radial cross-sectional view schematically illustrating the structure of a magnetic recording medium obtained by processing the workpiece;

FIG. 3 is a flowchart showing the outline of the manufacturing steps of the magnetic recording medium;

FIG. 4 is a radial cross-sectional view schematically illustrating the step of spreading a resin material over the workpiece;

FIG. 5 is a partially cross-sectional side view schematically illustrating the configuration of a light-transmitting stamper and a transferring apparatus according to the first exemplary embodiment;

FIG. 6 is a partially cross-sectional side view schematically illustrating the step of transferring a concavo-convex pattern to the resin material using the light-transmitting stamper;

FIG. 7 is a radial cross-sectional view schematically illustrating the shape of the workpiece including a recording layer processed to have a concavo-convex pattern;

FIG. 8 is a radial cross-sectional view schematically illustrating the shape of the workpiece in which a filling material is deposited over the recording layer;

FIG. 9 is a radial cross-sectional view schematically illustrating the shape of the workpiece in which the surfaces of recording elements and the filling material are flattened;

FIG. 10 is a partially cross-sectional side view schematically illustrating the configuration of a light-transmitting stamper and a transferring apparatus according to a second exemplary embodiment of the present invention;

FIG. 11 is a graph showing the relationship between the wavelength of light absorbed by a photo-polymerization initiator added to a resin material and the absorbance of the photo-polymerization initiator in Working Example 1 of the present invention;

FIG. 12 is a graph showing the relationship between the wavelength of light projected onto an ultraviolet filter and the transmittance of the ultraviolet filter in Working Example 4 of the present invention;

FIG. 13 is a graph showing the relationship between the wavelength of light absorbed by a photo-polymerization initiator added to a resin material and the absorbance of the photo-polymerization initiator in Comparative Example;

FIG. 14 is a graph showing the relationship, found in the course of arriving at the present invention, between the wavelength of light projected onto a light-transmitting stamper and the absorptance of the light-transmitting stamper;

FIG. 15 is a graph showing the relationship between the integrated light quantity of ultraviolet light contained in the light projected onto the light-transmitting stamper and the absorptance of the light-transmitting stamper for light having a wavelength of 400 nm and projected onto the light-transmitting stamper; and

FIG. 16 is a graph showing the relationship between the wavelength of the light projected onto the light-transmitting stamper and the relative intensity.

### DETAILED DESCRIPTION OF THE PREFERRED EMBODIMENTS

Hereinbelow, preferred exemplary embodiments of the present invention will be described in detail with reference to the drawings.

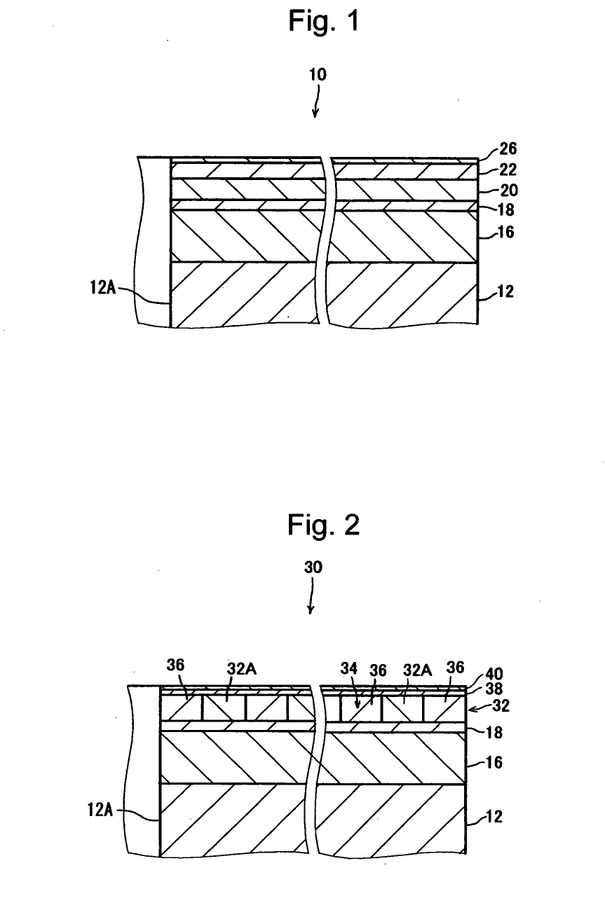

A first exemplary embodiment of the present invention relates to a method for manufacturing a magnetic recording medium (information recording medium). In this method, a starting body of a workpiece 10 shown in FIG. 1 is subjected to processing such as dry etching, and a recording layer of continuous film is thereby processed into a predetermined line-and-space pattern (data track pattern) shown in FIG. 2 and into a servo pattern (not shown). The method is characterized by a step of transferring a concavo-convex pattern to a resin material using a light-transmitting stamper, the resin material being used for processing the recording layer into a concavo-convex pattern. The descriptions of other components will be omitted as appropriate because they do not seem to be particularly important for the understanding of the first exemplary embodiment.

As shown in FIG. 1, the starting body of the workpiece 10 includes a substrate 12, a soft magnetic layer 16, a seed layer 18, a continuous recording layer 20, a first mask layer 22, and a second mask layer 26. These layers are formed over the substrate 12 in that order.

The substrate 12 has a substantially disk-like shape with a center hole 12A. Glass, Al, Al₂O₃, or the like may be used as the material for the substrate 12.

The soft magnetic layer 16 has a thickness of 50 to 300 nm. An Fe alloy, a Co alloy, or the like may be used as the material for the soft magnetic layer 16.

The seed layer 18 has a thickness of 2 to 40 nm. A nonmagnetic material such as a CoCr alloy, Ti, Ru, a laminate of Ru and Ta, MgO, or the like may be used as the material for the seed layer 18.

The recording layer 20 has a thickness of 5 to 30 nm. A CoCr-based alloy such as a CoCrPt alloy, an FePt-based alloy, a laminate thereof, a material formed of an oxide material, such as SiO₂, and ferromagnetic particles, such as CoPt particles, contained in the oxide material in a matrix form, or the like may be used as the material for the recording layer 20.

The first mask layer 22 has a thickness of 3 to 50 nm. C (carbon) may be used as the material for the first mask layer 22. For example, a hard carbon film, so-called diamond-like carbon (hereinafter referred to as “DLC”), may be used as the material for the first mask layer 22.

The second mask layer 26 has a thickness of 2 to 30 nm. Ni, Cu, Cr, Al, Al₂O₃, Ta, or the like may be used as the material for the second mask layer 26.

A magnetic recording medium 30 is a disk-shaped discrete track medium of a perpendicular recording type. In a data area, a recording layer 32 is formed to have a concavo-convex pattern formed by dividing the continuous recording layer 20 into a large number of concentric arc-shaped recording elements 32A arranged at small intervals in the radial direction, and FIG. 2 shows this shape. In a servo area, the recording layer 32 is divided into a large number of recording elements formed into a predetermined servo pattern (not shown). Moreover, concave portions 34 between the recording elements 32A are filled with a filling material 36, and a protection layer 38 and a lubrication layer 40 are formed in that order over the recording elements 32A and on the filling material 36.

SiO₂, C (carbon), DLC, a resin material, or the like may be used as the material for the filling material 36. The protection layer 38 has a thickness of 1 to 5 nm. DLC may be used as the material for the protection layer 38. The lubrication layer 40 has a thickness of 1 to 2 nm. PFPE (perfluoropolyether) may be used as the material for the lubrication layer 40.

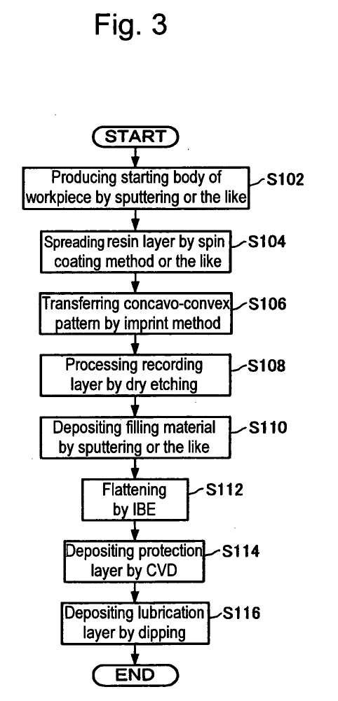

With reference to the flowchart shown in FIG. 3 and other figures, a description will now be given of the method for manufacturing the magnetic recording medium 30.

First, the starting body of a workpiece 10 is produced (S102) The starting body of the workpiece 10 is obtained by forming the soft magnetic layer 16, the seed layer 18, the continuous recording layer 20, the first mask layer 22, and the second mask layer 26 over the substrate 12 in that order by means of sputtering. When DLC is formed as the first mask layer 22, a CVD method is used. The soft magnetic layer 16 may be formed by means of a plating method.

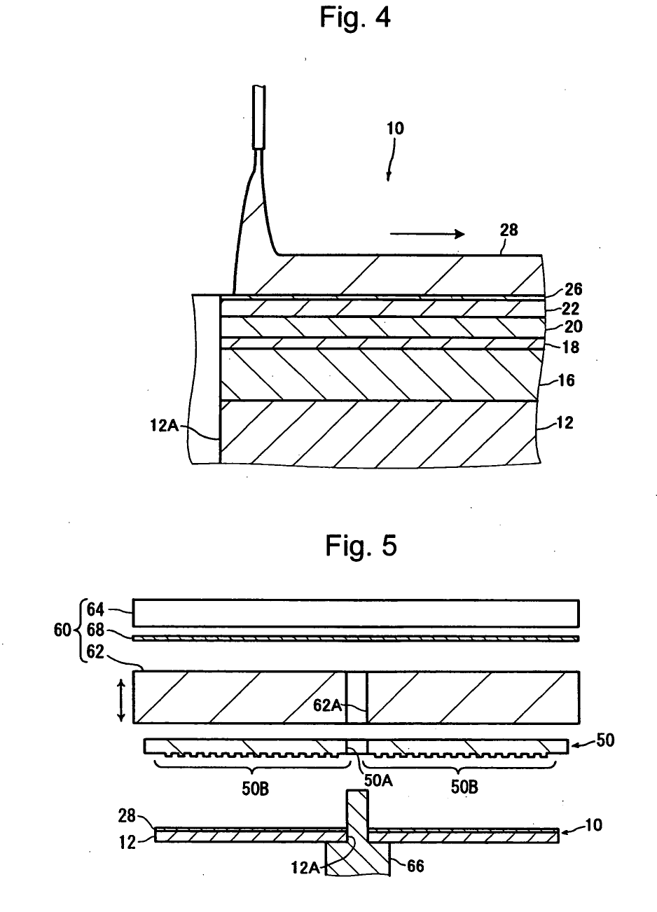

Next, as shown in FIG. 4, a resin material 28 which is visible light curable is spread over the second mask layer 26 of the workpiece 10 to a thickness of 30 to 300 nm by means of a spin coating method (S104). Specifically, a predetermined amount of the resin material 28 is supplied around the center hole 12A. Then, the workpiece 10 is rotated to allow the resin material 28 to spread over the second mask layer 26 by the centrifugal force. Alternatively, the resin material 28 may be spread over the second mask layer 26 by means of a dipping method.

For example, a resin material that is cured by irradiation with visible light having a wavelength longer than 400 nm can be used as the resin material 28. A resin material that is cured by irradiation with visible light having a wavelength of 405 nm or more is preferably used as the resin material 28. More preferably, a resin material that is cured by irradiation with visible light having a wavelength of 410 nm or more is used as the resin material 28. In addition, it is preferable that a resin material that is cured by irradiation with visible light having a wavelength of 600 nm or less be used as the resin material 28.

Specifically, a resin material can be used which is prepared by adding to various monomers or oligomers a photo-polymerization initiator that absorbs visible light to be activated (excited) and initiate the polymerization reaction of the monomers or oligomers.

In addition, a resin material can be used which is prepared by adding to various monomers or oligomers: a photo-polymerization initiator capable of initiating the polymerization reaction of the monomers or oligomers; and a sensitizer that absorbs visible light to activate (excite) the photo-polymerization initiator.

Examples of the above monomers and oligomers can include acrylic-based monomers and oligomers. More specifically, when an acrylic resin is prepared, the resin can be obtained by mixing oligomers of urethane acrylate, epoxy acrylate, silicon acrylate, or polyester acrylate and monomers having one to three functional groups, such as trimethylolpropane triacrylate, pentaerythritol triacrylate, hexanediol diacrylate, or hydroxyphenoxypropyl acrylate, while desired properties (curing properties, viscosity, shrinkage on curing, and adhesion properties) are taken into consideration.

Examples of the photo-polymerization initiator which can be used include: titanocene-based photo polymerization initiators such as bis(η5-2,4-cyclopentadiene-1-yl)-bis(2,6-difluoro-3-(1H-pyrrole-1-yl)-phenyl)titanium (IRGACURE (registered trademark) 784, product of Ciba Specialty Chemicals Inc.); acylphosphine oxide-based photo-polymerization initiators such as bis (2,4,6-trimethylbenzoyl)-phenylphosphine oxide (IRGACURE 819, product of Ciba Specialty Chemicals Inc.); thioxanthone-based photo-polymerization initiators such as isopropyl-9H-thioxanthen-9-one; and alkylphenone-based photo-polymerization initiators such as 2-methyl-1-(4-methylthiophenyl)-2-morpholinopropane-1-one (IRGACURE 907, product of Ciba Specialty Chemicals Inc.).

Examples of the sensitizer which can be used include isopropylthioxanthone.

Preferred examples of the combination of the above materials include a combination of the acrylic-based monomers or oligomers, and a photo polymerization initiator (bis(η5-2,4-cyclopentadiene-1-yl)-bis(2,6-difluoro-3-(1H-pyrrole-1-yl)-phenyl)titanium).

Other preferred examples of the combination of the above materials include a combination of the acrylic-based monomers or oligomers, a photo polymerization initiator (2-methyl-1-(4-methylthiophenyl)-2-morpholinopropane-1-one), and a sensitizer (isopropylthioxanthone).

Next, a concavo-convex pattern is transferred to the resin material 28 by means of an imprint method using a light-transmitting stamper 50 and a transferring apparatus 60 shown in FIG. 5 (S106).

The light-transmitting stamper 50 has a substantially disk-like shape with a center hole 50A and includes a transferring portion 50B having a concavo-convex pattern corresponding to the concavo-convex pattern of the recording layer 20. A light-transmitting material such as glass or resin such as polymethyl methacrylate, polyolefin, or polycarbonate may be used as the material for the light-transmitting stamper 50.

The transferring apparatus 60 includes an irradiation apparatus 64 and a stamper stage 62 which can apply pressure to s the resin material (transferring target) 28 through the light-transmitting stamper 50. The transferring apparatus 60 can project light onto the resin material 28 through the light-transmitting stamper 50. In this instance, the projected light is configured such that the integrated intensity of the light components having wavelengths longer than those of ultraviolet rays is grater than the integrated intensity of the ultraviolet components. The stamper stage 62 has a substantially disk-like shape with a center hole 62A. As in the light-transmitting stamper 50, a light-transmitting material such as glass or resin such as polymethyl methacrylate, polyolefin, or polycarbonate may used as the material for the stamper stage 62. The stamper stage 62 can be moved vertically by means of a driving apparatus (not shown).

Moreover, the transferring apparatus 60 includes a holder 66 which fits into the center hole 12A of the workpiece 10 to hold the workpiece 10. The holder 66 can also fit into the center hole 50A of the light-transmitting stamper 50 and into the center hole 62A of the stamper stage 62. Accordingly, the holder 66 is configured to adjust the positions of the workpiece 10, the light-transmitting stamper 50, and the stamper stage 62 such that the centers thereof coincide with each other.

The irradiation apparatus 64 has a light source such as a xenon lamp, a metal halide lamp, a high pressure mercury lamp, or a diode or semiconductor laser that can emit a laser beam having a wavelength longer than those of ultraviolet rays. The irradiation apparatus 64 is disposed above the stamper stage 62. An ultraviolet filter 68 is provided between the irradiation apparatus 64 and the stamper stage 62. Therefore, the light emitted from the irradiation apparatus 64 is reduced in irradiation intensity such that the amount of reduction in irradiation intensity of ultraviolet components (or components having wavelengths of 400 nm or less) is greater than that of light components having wavelengths longer than those of ultraviolet rays (or components having wavelengths longer than 400 nm). Then, this light is projected onto the resin material 28. For example, in the light having passed downwardly through the ultraviolet filter 68, the integrated intensity of the components having wavelengths longer than 400 nm is greater than the integrated intensity of the components having wavelengths of 400 nm or less. For example, an optically designed multilayer interference filter of a dielectric material, an absorption filter of a glass material or the like containing a material, such as copper halides, cerium, or lead, which absorbs ultraviolet light, or a similar filter may be used as the ultraviolet filter 68. Preferably, the transferring apparatus 60 can irradiate the resin material 28 substantially only with light having wavelengths longer than those of ultraviolet rays, except for ultraviolet rays contained in room light and the like. Also preferably, the transferring apparatus 60 can irradiate the resin material 28 substantially only with light having wavelengths longer than 400 nm, except for light having wavelength of 400 nm or less and contained in room light and the like.

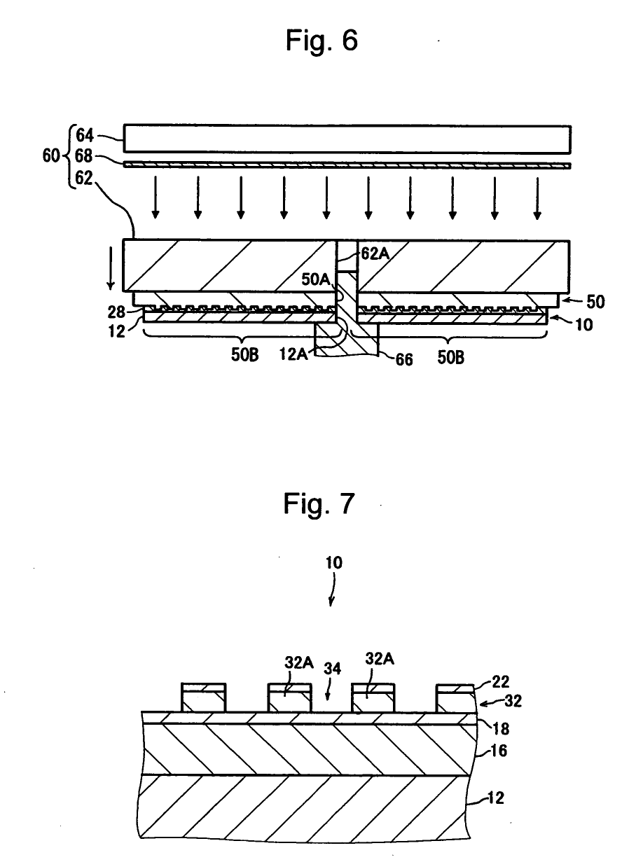

As shown in FIG. 6, the light-transmitting stamper 50 is placed on the workpiece 10 held by the holder 66 such that the transferring portion 50B comes into contact with the resin material 28. Subsequently, the stamper stage 62 is moved downward to apply pressure to the resin material 28 through the light-transmitting stamper 50 to transfer the concavo-convex pattern to the resin material 28. Then, the resin material 28 is irradiated with the light from the irradiation apparatus 64 through the ultraviolet filter 68, the stamper stage 62, and the light-transmitting stamper 50. In this irradiation light, the integrated intensity of the light components having wavelengths longer than those of ultraviolet rays is greater than the integrated intensity of the ultraviolet components. Accordingly, the resin material 28 increases in molecular weight due to polymerization or crosslinking reaction so as to be transformed into a solid state, thereby being cured. Note that, in FIG. 6, the arrows below the irradiation apparatus 64 schematically represent the direction of irradiation with the light. Furthermore, in FIGS. 5 and 6, the layers between the substrate 12 and the resin material 28 in the workpiece 10 are not illustrated. After the resin material 28 is cured, the stamper stage 62 is moved upward, and further the light-transmitting stamper 50 is separated away from the resin material 28.

Since the resin material 28 is visible light curable, it is cured sufficiently even when irradiated with light in which the integrated intensity of the light components having wavelengths longer than those of ultraviolet rays is greater than the integrated intensity of the ultraviolet components.

The absorptance of the stamper stage 62 and the light-transmitting stamper 50 increases as they deteriorate. Accordingly, the amount of the ultraviolet light reaching the resin material 28 gradually decreases. When the resin material 28 is curable by irradiation not only with visible light but also with ultraviolet light, the curing of the resin material 28 may be inhibited to some extent. However, since a reduction in the amount of the visible light reaching the resin material 28 is less than that of the ultraviolet light, the curing of the resin material 28 is less inhibited as compared to the case in which an ultraviolet curable resin that is not visible light curable is used. Therefore, also in this case, the effect of suppressing insufficient curing of the resin material 28 caused by the reduction in the amount of the ultraviolet light reaching the resin material 28 can be obtained.

Moreover, the resin material 28 is irradiated with the light in which the integrated intensity of the light components having wavelengths longer than those of ultraviolet rays (or the components having wavelengths longer than 400 nm) is greater than the integrated intensity of the ultraviolet components (or the components having wavelengths of 400 nm or less). Accordingly, the effect of suppressing insufficient curing of the resin material 28 caused by the reduction in the amount of the ultraviolet light (or the light having wavelengths of 400 nm or less) reaching the resin material 28 is enhanced.

An increase in the absorptance of the light-transmitting stamper 50 may be caused mainly because the light-transmitting stamper 50 is repeatedly irradiated with ultraviolet light (or light having wavelengths of 400 nm or less). However, the resin material 28 is irradiated with the light in which the integrated intensity of the light components having wavelengths longer than those of ultraviolet rays is greater than the integrated intensity of the ultraviolet components. Therefore, the deterioration of the light-transmitting stamper 50 and the increase in the absorptance due to the deterioration are suppressed. In addition, the deterioration of the stamper stage 62 and the increase in absorptance thereof due to the deterioration are suppressed.

Next, as shown in FIG. 7, based on the concavo-convex pattern of the resin material 28, the recording layer 20 is processed by means of dry etching to have a concavo-convex pattern (S108). Specifically, the resin material 28 on the bottom of each concave portion is first removed by means of RIE using an oxygen-based gas. Note that the resin material 28 in the convex portions is also partially removed, but the remaining convex portions have a height corresponding to the step height of the transferred concavo-convex pattern. Subsequently, based on the concavo-convex pattern of the resin material 28, the second mask layer 26 at the bottom of each concave portion is removed by means of, for example, IBE using an inert gas such as Ar, Kr, or Xe, and the first mask layer 22 at the bottom of each concave portion is removed by means of, for example, RIE using a halogen-based gas. Furthermore, the exposed portion of the continuous recording layer 20 at the bottom of each concave portion is removed by means of, for example, IBE using an inert gas such as Ar. In this manner, the continuous recording layer 20 is divided into a large number of the recording elements 32A, and the recording layer 32 having the concavo-convex pattern is formed. At this point, almost all the resin material 28 and the second mask layer 26 over the recording elements 32A are removed. The first mask layer 22 remaining over the recording elements 32A is completely removed by means of, for example, RIE using an oxygen-based gas, a halogen-based gas, or a hydrogen-based gas such as NH₃ or H₂.

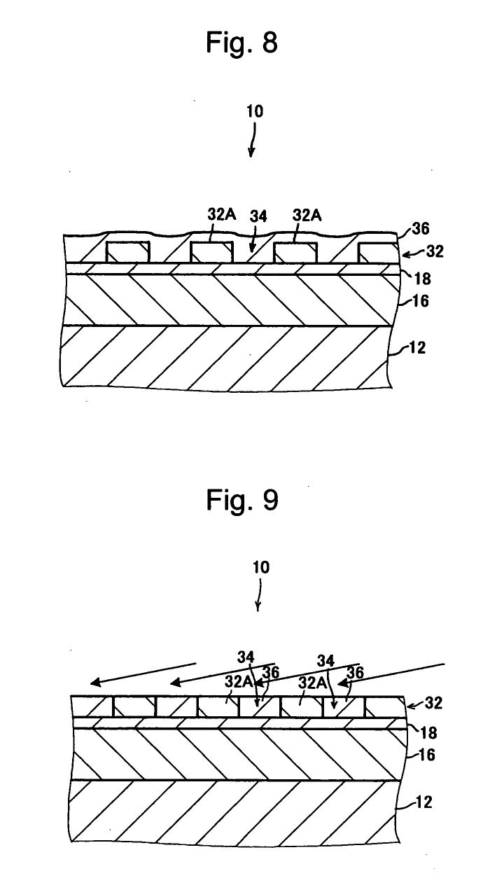

Next, as shown in FIG. 8, the filling material 36 is deposited over the recording layer 32 having the concavo-convex pattern by means of sputtering or bias sputtering, and therefore the concave portions 34 between the recording elements 32A are filled with the filling material 36 (S110). Note that when a resin material is used as the filling material 36, the filling material 36 is deposited by means of a spin coating method.

Next, as shown in FIG. 9, the filling material 36 deposited on upper side (the side opposite to the substrate 12) of the upper surfaces of the recording elements 32A is removed by means of IBE using an inert gas such as Ar, whereby the surfaces of the recording elements 32A and the filling material 36 are flattened (S112). Note that, in FIG. 9, the arrows schematically represent the direction of irradiation with the processing gas.

Next, the protection layer 38 is formed over the recording elements 32A and the filling material 36 by means of a CVD method (S114).

Moreover, the lubrication layer 40 is applied to the protection layer 38 by means of a dipping method (S116). In this manner, the magnetic recording medium 30 shown in FIG. 2 is completed.

A description will now be given of a second exemplary embodiment of the present invention.

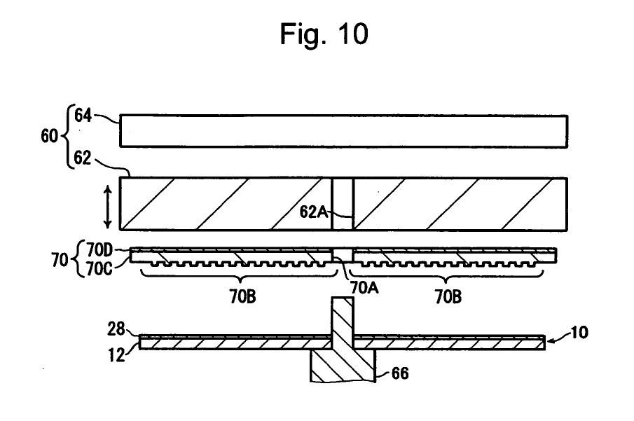

In the first exemplary embodiment, in the transferring step (S106), the ultraviolet filter 68 is provided between the irradiation apparatus 64 and the stamper stage 62, so that the resin material 28 is irradiated with the light in which the integrated intensity of the light components having wavelengths longer than those of ultraviolet rays is greater than the integrated intensity of the ultraviolet components. However, in the second exemplary embodiment, as shown in FIG. 10, a light-transmitting stamper 70 is used in the transferring step (S106). In the light-transmitting stamper 70, the transmittance for ultraviolet rays (or light having wavelengths of 400 nm or less) is less than the transmittance for light having wavelengths longer than those of ultraviolet lays (or light having wavelengths longer than 400 nm). Note that an ultraviolet filter is not provided between the irradiation apparatus 64 and the stamper stage 62. Since other components are the same as those in the first exemplary embodiment, the same reference numerals as in FIGS. 1 to 9 are used, and redundant description is omitted as appropriate.

The light-transmitting stamper 70 has a substantially disk-like shape with a center hole 70A and includes: a base portion 70C having a transferring portion 70B in which a concavo-convex pattern corresponding to the concavo-convex pattern of the recording layer 32 is formed; and an ultraviolet filter 70D which is disposed on the side opposite to the transferring portion 70B so as to cover the base portion 70C. In the ultraviolet filter 70D, the transmittance for ultraviolet rays (or light having wavelengths of 400 nm or less) is less than the transmittance for light having wavelengths longer than those of ultraviolet rays (or light having wavelengths longer than 400 nm). A material similar to that for the ultraviolet filter 68 may be used as the material for the ultraviolet filter 70D. Preferably, the ultraviolet filter 70D allows substantially only light having wavelengths longer than those of ultraviolet rays to pass therethrough. Also preferably, the ultraviolet filter 70D allows substantially only light having wavelengths longer than 400 nm to pass therethrough.

As described above, the light-transmitting stamper 70 is used in which the transmittance for ultraviolet rays is less than the transmittance for light having wavelengths longer than those of the ultraviolet rays. Even in this case, the resin material 28 is cured sufficiently because the resin material 28 is visible light curable.

The base portion 70C of the light-transmitting stamper 70 is irradiated with the light in which the integrated intensity of the light components having wavelengths longer than those of ultraviolet rays is greater than the integrated intensity of the ultraviolet components. Therefore, the deterioration of the base portion 70C due to ultraviolet light is suppressed.

In the first exemplary embodiment, the ultraviolet filter 68 is provided between the irradiation apparatus 64 and the stamper stage 62. In the second exemplary embodiment, the light-transmitting stamper 70 is used in which the transmittance for ultraviolet rays is less than the transmittance for light having wavelengths longer than those of the ultraviolet rays. Alternatively, for example, an ultraviolet filter may be disposed between the light-transmitting stamper 50 and the stamper stage 62, and the resin material 28 may be irradiated with light in which the integrated intensity of the light components having wavelengths longer than those of ultraviolet rays is greater than the integrated intensity of the ultraviolet components.

Furthermore, in the first and second exemplary embodiments, the resin material is irradiated using the ultraviolet filter with the light in which the integrated intensity of the light components having wavelengths longer than those of ultraviolet rays is greater than the integrated intensity of the ultraviolet components. Alternatively, the ultraviolet filter may be omitted when an irradiation apparatus is used which has a light source, such as a diode or semiconductor laser emitting a laser beam, capable of emitting only light having a wavelength longer than those of ultraviolet rays.

Moreover, the ultraviolet filter may be omitted when a light-transmitting stamper is used which contains, for example, copper halide, cerium, or lead which absorbs ultraviolet light. In such a light-transmitting stamper, the transmittance for ultraviolet rays is less than the transmittance for light having wavelengths longer than those of the ultraviolet rays.

Furthermore, in the first and second exemplary embodiments, the light-transmitting stamper 50 or 70 and the stamper stage 62 are independent of each other and are successively moved downward to the workpiece 10. Alternatively, the light-transmitting stamper may be held by the stamper stage using negative pressure or adhesion, so that they are integrally moved downward to the workpiece 10.

In the first and second exemplary embodiments, the resin material is irradiated with the light in which the integrated intensity of the light components having wavelengths longer than those of ultraviolet rays is greater than the integrated intensity of the ultraviolet components. Alternatively, the resin material may be irradiated with light in which the integrated intensity of the light components having wavelengths longer than those of ultraviolet rays is equal to, or less than, the integrated intensity of the ultraviolet components. In such a case, when the light-transmitting stamper 50 is repeatedly used, the ratio of the ultraviolet light absorbed by the light-transmitting stamper is likely to increase gradually, and the ratio of the ultraviolet light reaching the resin material is likely to decrease gradually. However, even when such a phenomenon occurs, the visible light curable resin material absorbs visible light and is cured sufficiently.

When the resin material is curable by irradiation not only with visible light but also with ultraviolet light, the amount of the ultraviolet light reaching the resin material decreases gradually, and therefore the curing of the resin material may be inhibited to some extent. However, since changes in the amount of visible light reaching the resin material are small as described above, the curing of the resin material is less inhibited as compared to the case in which an ultraviolet curable resin that is not curable by irradiation with visible light is used.

Moreover, in the first and second exemplary embodiments, the recording layer 20 is divided thoroughly in the recording layer processing step (S110). Alternatively, a recording layer having a concavo-convex pattern in which the recording layer is continuous under the concave portions may be formed by processing the recording layer to midway point in the thickness direction.

Furthermore, in the first and second exemplary embodiments, the soft magnetic layer 16 and the seed layer 18 are formed below the recording layer 20 (32). The configuration of the layers below the recording layer 20 (32) may be changed appropriately according to the type of the magnetic recording medium. For example, an antiferromagnetic layer and/or an underlayer may be formed below the soft magnetic layer 16. Moreover, one of the soft magnetic layer 16 and the seed layer 18 may be omitted. Furthermore, the recording layer 20 (32) may be formed directly on the substrate 12.

Moreover, in the first and second exemplary embodiments, examples are shown in which the recording layer 32 is provided on one side of the substrate 12. The present invention is also applicable to the case in which a magnetic recording medium having a recording layer on both sides of the substrate is manufactured.

Furthermore, in the first and second exemplary embodiments, the magnetic recording medium 30 is a discrete track medium of a perpendicular recording type in which the recording elements 32A are formed in a track shape in the data area. The present invention is also applicable to the manufacturing of patterned media including recording elements formed by circumferentially dividing tracks and of magnetic disks including recording elements formed in a spiral shape. Moreover, the present invention is applicable to the manufacturing of magneto-optical disks such as MO disks, of heat assisted type recording disks in which both magnetism and heat are utilized, and of magnetic recording media, such as magnetic tapes, having a shape different from a disk-like shape.

Moreover, in the first and second exemplary embodiments, examples of the manufacturing of the magnetic recording media are shown. However, the present invention is applicable to the manufacturing of other types of information recording media such as optical recording media.

### Working Example 1

In contrast to the first exemplary embodiment, the ultraviolet filter 68 was omitted, and the transferring step (S106) was performed.

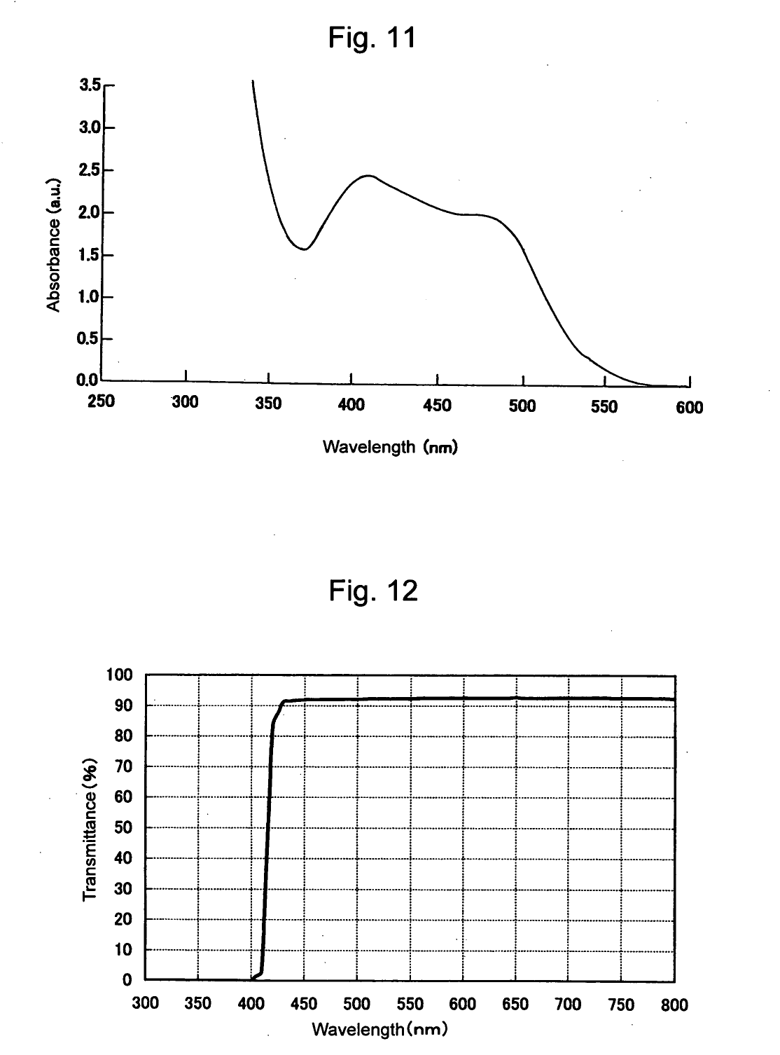

Specifically, the resin material 28 was spread over the starting body of a workpiece 10 to a thickness of 70 nm. The diameter of the workpiece 10 was 48 mm. A resin material was prepared by diluting oligomers of urethane acrylate and monomer of pentaerythritol triacrylate with propylene glycol monomethyl ether acetate (PGMEA) solvent and adding thereto bis(η5-2,4-cyclopentadiene-1-yl)-bis(2,6-difluoro-3-(1H-pyrrole-1-yl)-phenyl) titanium (IRGACURE 784, product of Ciba Specialty Chemicals Inc.) serving as a photo-polymerization initiator. The prepared resin material was used as the resin material 28. The weight ratio of the components except for the solvent, i.e., the weight ratio of the oligomers of urethane acrylate, the monomer of pentaerythritol triacrylate, and the photo-polymerization initiator was 45:54:1. FIG. 11 is a graph showing the relationship between the wavelength of light absorbed by the photo-polymerization initiator and the absorbance.

The transferring portion SOB of the light-transmitting stamper 50 was brought into contact with the resin material 28, and the resin material 28 was pressed under a load of 3.6 MPa for 10 minutes. Subsequently, the resin material 28 was irradiated with light through the light-transmitting stamper 50 using the irradiation apparatus described above (Spot-Cure SP5, product of USHIO INC.). The output power of the irradiation apparatus was set to 250 W, and the irradiation area was set to φ80 mm. Irradiation was performed for 20 seconds, and then the light-transmitting stamper 50 was separated from the resin material 28. The material for the light-transmitting stamper 50 was polyolefin having an amorphous structure.

The same light-transmitting stamper 50 was used repeatedly, and this step was performed 100 times. In all the cases, the resin material 28 was cured sufficiently.

### Working Example 2

In contrast to Working Example 1, a resin material was prepared by diluting oligomers of urethane acrylate and monomer of pentaerythritol triacrylate with propylene glycol monomethyl ether acetate (PGMEA) solvent and adding thereto 2-methyl-1-(4-methylthiophenyl)-2-morpholinopropane-1-one (IRGACURE 907, product of Ciba Specialty Chemicals Inc.) serving as a photo-polymerization initiator and further adding thereto isopropylthioxanthone serving as a sensitizer, and was used as the resin material 28. The weight ratio of the components except for the solvent, i.e., the weight ratio of the oligomers of urethane acrylate, the monomer of pentaerythritol triacrylate, the photo-polymerization initiator, and the sensitizer was 45:53:1:1. 2-methyl-1-(4-methylthiophenyl)-2-morpholinopropane-1-one only absorbs light in the ultraviolet range and does not absorb visible light. However, the molecular extinction coefficient ε of isopropylthioxanthone at a wavelength of light of 450 nm is 102. This means that isopropylthioxanthone absorbs visible light.

The other conditions were the same as those in Working Example 1. As in Working Example 1, the same light-transmitting stamper 50 was used repeatedly, and the transferring step (S106) was performed 100 times. In all the cases, the resin material 28 was cured sufficiently. As described above, 2-methyl-1-(4-methylthiophenyl)-2-morpholinopropane-1-one only absorbs light in the ultraviolet range and does not absorb visible light. However, it is considered that the sensitizing effect due to isopropylthioxanthone allows the crosslinking reaction through irradiation with visible light to proceed.

### Working Example 3

An unused light-transmitting stamper 50 the same as those used in Working Examples 1 and 2 was prepared, and the absorptance thereof was measured at wavelengths of light in the range of 400 to 800 nm.

Next, the light-transmitting stamper 50 was irradiated with a monochromatic laser beam having a wavelength of 405 nm (longer than 400 nm). When the accumulated light quantity reached 20 J/cm², the absorptance was again measured at wavelengths of light in the range of 400 to 800 nm. There was no difference in absorptance between the unused light-transmitting stamper 50 with an accumulated light quantity of 0 J/cm² and the light-transmitting stamper 50 with an accumulated light quantity of 20 J/cm².

### Working Example 4

In contrast to Working Example 1, the ultraviolet filter 68 was used as in the first exemplary embodiment, and the transferring step (S106) was performed. FIG. 12 is a graph showing the relationship between the wavelength of light projected onto the ultraviolet filter 68 and the transmittance of the ultraviolet filter 68.

The other conditions were the same as those in Working Example 1. As in Working Example 1, the same light-transmitting stamper 50 was used repeatedly, and the transferring step (S106) was performed 100 times. In all the cases, the resin material 28 was cured sufficiently.

Before the transferring step (S106) was performed, the absorptance of an unused light-transmitting stamper 50 was measured at wavelengths of light in the range of 400 to 800 nm. In addition, after the transferring step (S106) was repeated 100 times, the absorptance of the light-transmitting stamper 50 was measured at wavelengths of light in the range of 400 to 800 nm. There was no difference in absorptance between the unused light-transmitting stamper 50 with an accumulated light quantity of 0 J/cm² and the light-transmitting stamper 50 after the transferring step (S106) was repeated 100 times.

### Working Example 5

In contrast to Working Example 2, the ultraviolet filter 68 the same as that used in Working Example 4 was used, and the transferring step (S106) was performed.

The other conditions were the same as those in Working Example is 2. As in Working Example 2, the same light-transmitting stamper 50 was used repeatedly, and the transferring step (S106) was performed 100 times. In all the cases, the resin material 28 was cured sufficiently.

As described above, 2-methyl-1-(4-methylthiophenyl)-2-morpholinopropane-1-one only absorbs light in the ultraviolet range and does not absorb visible light. However, it is considered that the sensitizing effect due to isopropylthioxanthone allows the crosslinking reaction through irradiation only with visible light to proceed.

### Comparative Example

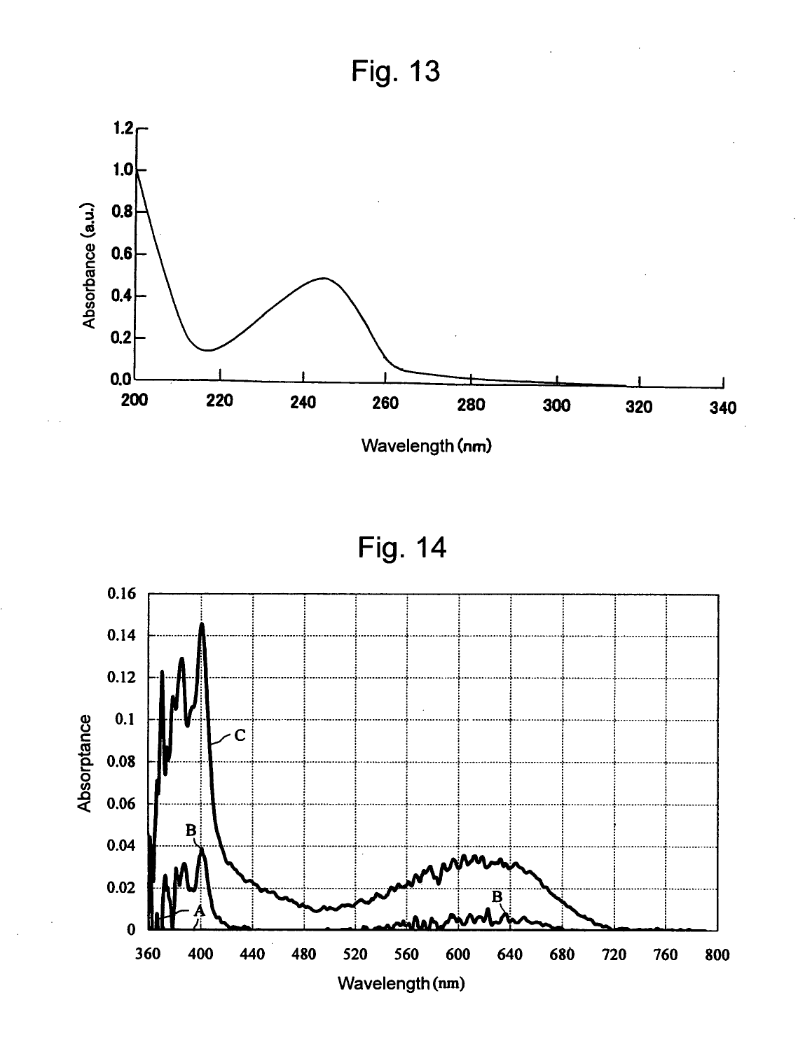

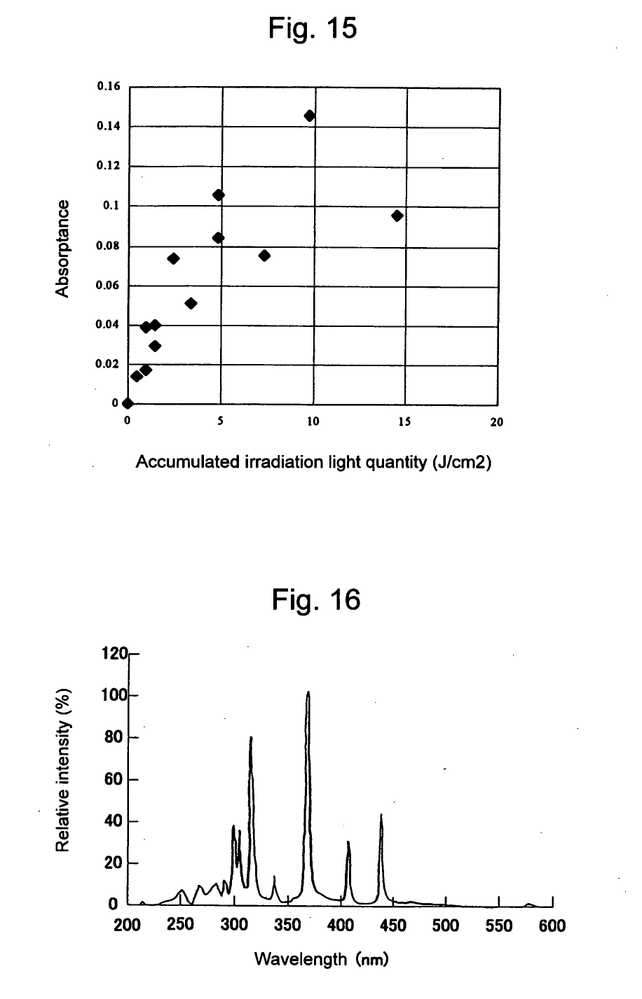

In contrast to Working Example 1, a resin material was prepared by diluting oligomers of urethane acrylate and monomer of pentaerythritol triacrylate with propylene glycol monomethyl ether acetate (PGMEA) solvent and adding thereto 1-hydroxy-cyclohexyl-phenyl-keton (IRGACURE 184, product of Ciba Specialty Chemicals Inc.) serving as a photo-polymerization initiator. The weight ratio of the components except for the solvent, i.e., the weight ratio of the oligomers of urethane acrylate, the monomer of pentaerythritol triacrylate, and the photo-polymerization initiator was 45:54:1. FIG. 13 is a graph showing the relationship between the wavelength of light absorbed by the photo-polymerization initiator and the absorbance. The other conditions were the same as those in Working Example 1.

As in Working Example 1, the same light-transmitting stamper 50 was used repeatedly, and the transferring step (S106) was repeated. The resin material was cured sufficiently until the nineteenth repetition. However, at the twentieth repetition, the resin material was not cured sufficiently, and a part of the resin material was peeled off the workpiece 10 when the light-transmitting stamper 50 was separated from the resin material. This may be because of the following reason. Since the light projected onto the light-transmitting stamper 50 contained ultraviolet light, the light-transmitting stamper 50 deteriorated, so that the absorptance of the light-transmitting stamper 50 increased. Therefore, the amount of the ultraviolet light passing through the light-transmitting stamper 50 was gradually decreased, and the ratio of the ultraviolet light reaching the ultraviolet curable resin material was decreased. Accordingly, the ultraviolet curable resin material (which is not visible light curable) was not cured sufficiently.

However, in Working Examples 1, 2, 4, and 5 in which the visible light curable resin material was used, the resin material 28 was not peeled off in any of 100 repetitions of the transferring step (S106). In other words, it was found that, by using the resin material which is visible light curable, the resin material can be reliably cured even when the light-transmitting stamper is used repeatedly.

What is claimed is:

1. A method for manufacturing an information recording medium, comprising:
a resin material spreading step of spreading a resin material which is visible light curable over a workpiece; and
a transferring step of bringing a light-transmitting stamper including a transferring portion having a predetermined concavo-convex pattern formed therein into contact with the resin material to transfer the concavo-convex pattern to the resin material and projecting light including visible light onto the resin material through the light-transmitting stamper to cure the resin material.

2. The method for manufacturing an information recording medium according to claim 1, wherein, in the transferring step, the resin material is irradiated with light in which an integrated intensity of light components having wavelengths longer than those of ultraviolet rays is greater than an integrated intensity of ultraviolet components.

3. The method for manufacturing an information recording medium according to claim 1, wherein, in the transferring step, the resin material is irradiated with light in which an integrated intensity of light components having wavelengths longer than 400 nm is greater than an integrated intensity of light components having wavelength of 400 nm or less.

4. The method for manufacturing an information recording medium according to claim 1, wherein, in the transferring step, light emitted from an irradiation apparatus is reduced in irradiation intensity such that an amount of reduction in irradiation intensity of ultraviolet components is greater than an amount of reduction in irradiation intensity of light components having wavelengths longer than those of ultraviolet rays, and the light is projected onto the resin material.

5. The method for manufacturing an information recording medium according to claim 1, wherein, in the transferring step, light emitted from an irradiation apparatus is reduced in irradiation intensity such that an amount of reduction in irradiation intensity of light components having wavelengths of 400 nm or less is grater than an amount of reduction in irradiation intensity of light components having wavelengths longer than 400 nm, and the light is projected onto the resin material.

6. The method for manufacturing an information recording medium according to claim 1, wherein, in the transferring step, the resin material is irradiated substantially only with light having wavelengths longer than those of ultraviolet rays.

7. The method for manufacturing an information recording medium according to claim 1, wherein, in the transferring step, the resin material is irradiated substantially only with light having wavelengths longer than 400 nm.

8. A method for forming a resin mask, comprising:
a resin material spreading step of spreading a resin material which is visible light curable over a workpiece; and
a transferring step of bringing a light-transmitting stamper including a transferring portion having a predetermined concavo-convex pattern formed therein into contact with the resin material to transfer the concavo-convex pattern to the resin material and projecting light including visible light onto the resin material through the light-transmitting stamper to cure the resin material.

9. A transferring apparatus comprising:
a stamper stage which can apply a pressure to a transferring target through a light-transmitting stamper including a transferring portion having a predetermined concavo-convex pattern formed therein; and
an irradiation apparatus, wherein
light in which an integrated intensity of light components having wavelengths longer than those of ultraviolet rays is greater than an integrated intensity of ultraviolet components can be projected onto the transferring target through the light-transmitting stamper.

10. A transferring apparatus comprising:
a stamper stage which can apply a pressure to a transferring target through a light-transmitting stamper including a transferring portion having a predetermined concavo-convex pattern formed therein;
an irradiation apparatus which can project light including visible light onto the transferring target through the light-transmitting stamper; and
a filter which is disposed between the transferring portion of the light-transmitting stamper and the irradiation apparatus and can reduce an irradiation intensity of light emitted from the irradiation apparatus such that an amount of reduction in irradiation intensity of ultraviolet components is greater than an amount of reduction in irradiation intensity of light components having wavelengths longer than those of ultraviolet rays.

11. The transferring apparatus according to claim 9, wherein the transferring target can be irradiated substantially only with light having wavelengths longer than those of ultraviolet rays.

12. The transferring apparatus according to claim 10, wherein the transferring target can be irradiated substantially only with light having wavelengths longer than those of ultraviolet rays.

13. A light-transmitting stamper comprising a transferring portion having a predetermined concavo-convex pattern formed therein, wherein a transmittance thereof for ultraviolet rays is less than a transmittance thereof for light having wavelengths longer than those of the ultraviolet rays.

14. The light-transmitting stamper according to claim 13, wherein substantially only light having wavelengths longer than those of ultraviolet rays is allowed to pass therethrough.

15. The light-transmitting stamper according to claim 13, comprising:
a base portion including the transferring portion and allowing light having a wavelength longer than those of ultraviolet rays to pass therethrough; and
an ultraviolet filter in which a transmittance thereof for ultraviolet rays is less than a transmittance thereof for light having a wavelength longer than those of ultraviolet rays.

16. The light-transmitting stamper according to claim 14, comprising:
a base portion including the transferring portion and allowing light having a wavelength longer than those of ultraviolet rays to pass therethrough; and
an ultraviolet filter in which a transmittance thereof for ultraviolet rays is less than a transmittance thereof for light having a wavelength longer than those of ultraviolet rays.
